(19) United States
(12) Patent Application Publication
(10) Pub. No.: US 2011/0129600 A1
(43) Pub. Date: Jun. 2, 2011

(54) COLD SPRAY DEPOSITION PROCESSES FOR MAKING NEAR NET SHAPE COMPOSITE AIRFOIL LEADING EDGE PROTECTIVE STRIPS AND COMPOSITE AIRFOILS COMPRISING THE SAME

(76) Inventors: NRIPENDRA NATH DAS, Cincinnati, OH (US); Michael Rucker, Cincinnati, OH (US); Brian Pilsner, Cincinnati, OH (US); Anthony Reynolds, Cincinnati, OH (US)

(21) Appl. No.: 12/627,662

(22) Filed: Nov. 30, 2009

(51) Int. Cl. B05D 1/06

(52) U.S. Cl. 427/201

(57) ABSTRACT

Methods for making a leading edge protective strip for a composite airfoil including utilizing a cold spray deposition system to deposit a protective strip onto a leading edge of the composite airfoil.

### TECHNICAL FIELD

Embodiments described herein generally relate to cold spray deposition processes for making near net shape composite airfoil leading edge protective strips and composite airfoils comprising the same.

### BACKGROUND OF THE INVENTION

Many modern turbine engine airfoils, such as fan blades and stator vanes, are constructed of composite laminate or molded fiber. Airfoil metal leading edges (herein “MLE”) are used to protect such composite airfoils from impact and erosion damage that can often occur in the engine environment. In conventional practices, a v-shaped protective metallic strip is often wrapped around the leading edge and sides of the airfoil to provide such protection.

Unfortunately, the thin metallic strips bonded to the leading edge of the airfoil may become detached during engine operation. Detachment can typically be attributed to bonding failure caused by strain mismatch between the metal strip and the underlying composite material of the airfoil during operation at elevated temperatures. Detachment of leading edge strips can result in unacceptable domestic object damage (DOD) to the airfoils and other engine components located downstream in the engine flowpath. Moreover, increasingly complex airfoil shape requirements dictate a solid nose profile and a thin cross section, thereby prohibiting the use of the previously utilized leading edge wrap.

Additionally, current leading edge wraps are typically manufactured using hot forming methods, or machining from bar stock or near net shape (NNS) forgings. Such manufacturing processes can lead to high tooling costs, high yield losses, and environmentally unfriendly processing. These drawbacks are especially true when fabricating thin, complex geometries, such as MLEs. Moreover, because of the high temperatures involved, hot forming methods can prohibit the deposition of the material of manufacture directly onto a composite component due to the likelihood of damage to the composite.

Accordingly, there remains a need for manufacturing methods that address and overcome the previously discussed issues associated with conventional MLE protective strips and the manufacture thereof.

### BRIEF DESCRIPTION OF THE INVENTION

Embodiments herein generally relate to methods for making a leading edge protective strip for a composite airfoil comprising: utilizing a cold spray deposition system to deposit a protective strip onto a leading edge of the composite airfoil.

Embodiments herein also generally relate to methods for making a leading edge protective strip for a composite airfoil comprising: utilizing a cold spray deposition system to deposit the protective strip onto a leading edge of the composite airfoil wherein the protective strip comprises a metal selected from the group consisting of titanium, titanium alloy, nickel-chromium alloy, aluminum, and combinations thereof; and the composite comprises a material selected from the group consisting of carbon fibers, graphite fibers, glass fibers, ceramic fibers, aramid polymer fibers, and combinations thereof.

Embodiments herein also generally relate to methods for making a leading edge protective strip for a composite airfoil comprising: feeding a first gas stream and a second gas stream into a nozzle, the first gas stream being heated to a temperature of from about 260° C. to about 1038° C., and the second gas stream comprising a metallic powder selected from the group consisting of titanium, titanium alloy, nickel-chromium alloy, aluminum, and combinations thereof; combining the first gas stream and the second gas stream in the nozzle to form a deposit stream; and applying the deposit stream to the composite airfoil at a velocity of from about Mach 0.5 to about Mach 1.0 and at a temperature of from about 200° C. to about 1000° C. to build up a deposit and form the metal leading edge protective strip.

These and other features, aspects and advantages will become evident to those skilled in the art from the following disclosure.

### BRIEF DESCRIPTION OF THE DRAWINGS

While the specification concludes with claims particularly pointing out and distinctly claiming the invention, it is believed that the embodiments set forth herein will be better understood from the following description in conjunction with the accompanying figures, in which like reference numerals identify like elements.

FIG. 1 is a schematic representation of one embodiment of a composite fan blade for a gas turbine engine having an MLE protective strip in accordance with the description herein;

FIG. 2 is a schematic representation of one embodiment of a cold spray deposition system in accordance with the description herein.

### DETAILED DESCRIPTION OF THE INVENTION

Embodiments described herein generally relate to cold spray deposition processes for making near net shape composite airfoil leading edge protective strips and composite airfoils comprising the same.

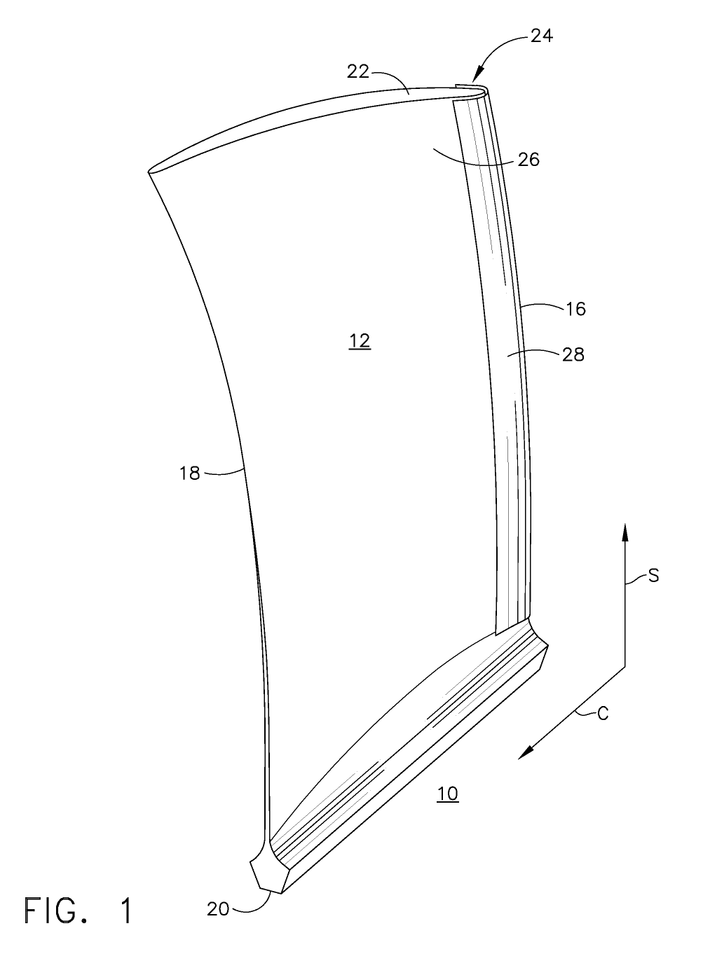

FIG. 1 is a composite fan blade 10 for a gas turbine engine having a composite airfoil 12 generally extending in a chordwise direction C from a leading edge 16 to a trailing edge 18. Airfoil 12 extends radially outward in a spanwise direction S from a root 20 to a tip 22 generally defining its span and having a suction side 24 and a pressure side 26. Airfoil 12 can be constructed from composite material as is conventional for airfoil manufacture. As used herein, “composite” refers to any woven, braided, or non-crimp fabric capable of being infused with a resin and cured to produce a composite material, such as carbon fibers, graphite fibers, glass fibers, ceramic fibers, and aramid polymer fiber. Embodiments herein describe methods for making a metal leading edge (MLE) protective strip 28 for adhesion to airfoil leading edge 16, the protective strip 28 comprising a metal selected from titanium, titanium alloy, nickel-chromium alloy (e.g. Inconel 718), aluminum, or combination thereof. Though embodiments herein focus on composite fan blades, the methods, tooling and MLE protective strips herein are suitable for use with any composite airfoil, including any blades and vanes.

MLE protective strip 28 can be made using cold spray deposition processes. As used herein, “cold spray deposition” refers to conventional solid-state processes that generally involve fluidizing a fine (micron or sub-micron) metal powder in a stream of helium, or other inert gas, before spraying the resulting powder and gas mixture directly through a nozzle at nearly sonic velocities, thereby causing the accelerated metal powders to impact the composite surface with sufficient force to establish an interfacial bond between the composite and the deposit material. Such processes are referred to as “cold” technologies because of the relatively low temperatures of the gas/powder stream upon impact with the composite substrate.

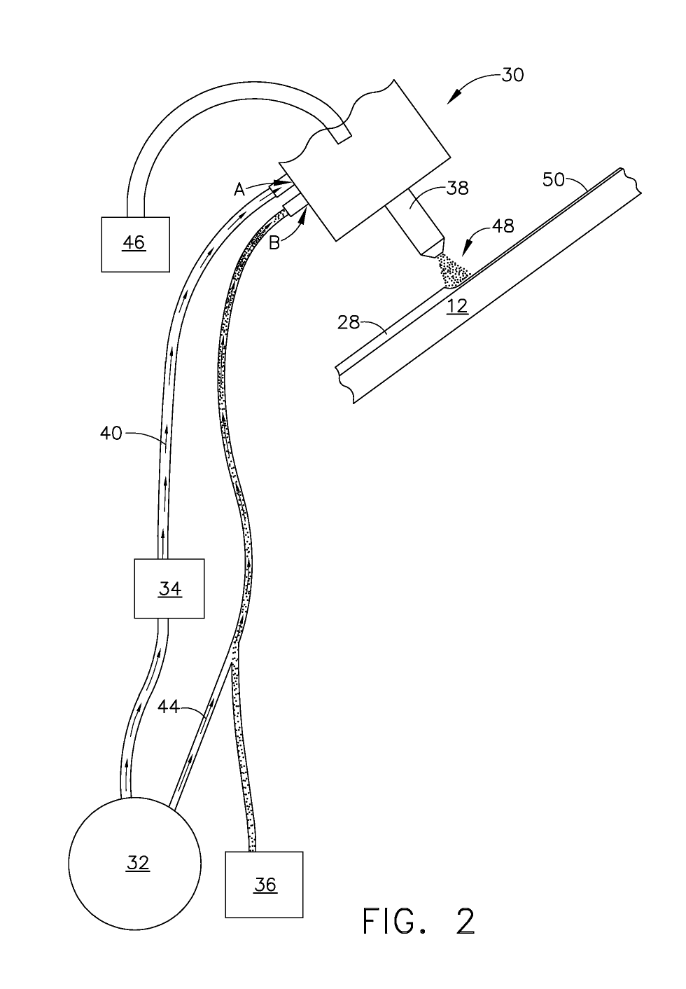

Embodiments of cold spray deposition system 30 described herein can generally comprise a gas source 32, a gas heater 34, a powder metering device 36, a nozzle 38, and a motion control device 46, for depositing MLE protective strip 28 onto composite airfoil 12, as shown generally in FIG. 2, and as explained herein below.

In the embodiments herein, pressurized first gas stream 40 (as indicated by arrows) can be fed from gas source 32 to gas heater 34, and then to nozzle 38. First gas stream 40 can comprise a gas selected from the group consisting of nitrogen, helium, other like inert gases, and combinations thereof, and can be fed from gas source 32 to gas heater 34 at a pressure of from about 50 psi to about 150 psi. Gas heater 34 can heat first gas stream 40 to a temperature of from about 500° F. (260° C.) to about 1900° F. (1038° C.), and in one embodiment about 625° F. (329° C.) using conventional heating techniques before feeding the resulting heated first gas stream 40 to nozzle 38, again at a pressure of from about 50 psi to about 150 psi.

Simultaneously, a metallic powder 42 from powder metering device 36 can be combined with a second gas stream 44 (as indicated by arrows) from gas source 32, and fed to nozzle 38. Metallic powder 42 can be selected from the group consisting of titanium, titanium alloy, nickel-chromium alloy (e.g. Inconel 718), and aluminum, and can comprise a particle size of from about 5 micrometers to about 100 micrometers. Fine particle sizes such as these can provide for increased deformation, which in turn, can result in better adhesion to the composite airfoil. The powder feed rate of metallic powder 42 into second gas stream 44 can be from about 1 gm/minute to about 20 gm/minute, and in one embodiment, about 10 gm/minute. Such powder feed rate can be used to increase or decrease the thickness of the deposit, as well as tailor the microstructure and mechanical properties of the deposit as desired. Second gas stream 44 can comprise the same gas as first gas stream 40, since both originate at gas source 32. Like first gas stream 40, second gas stream 44 can be fed at a pressure of from about 50 psi to about 150 psi.

Nozzle 38 can be a conventional converging/diverging nozzle to accommodate the mixing of gas streams 40, 44 and metallic powder 42. Heated first gas stream 40 can be introduced into nozzle 38 at A. Metallic powder 42, propelled by second gas stream 44, can be introduced into nozzle 38 at B, where it can mix with, and be accelerated by, heated first gas stream 40. Heated first gas stream 40 can promote increased flow velocities of metallic powder 42, which in turn can result in higher impact velocities of the metallic powder onto composite airfoil 12, as described below.

Heated first gas stream 40, second gas stream 44, and metallic powder 42, can combine in nozzle 38 to form deposit stream 48, which can exit nozzle 38 and impact composite airfoil 12 to build up MLE protective strip 28. More particularly, deposit stream 48 can exit nozzle 38 at a velocity of from about Mach 0.5 to about Mach 1, and a temperature of from about 392° F. (200° C.) to about 1832° F. (1000° C.). Impacting composite airfoil 12 under such conditions can establish an interfacial bond between metallic powder 42 present in deposit stream 48 and composite airfoil 12 without damaging composite airfoil 12.

Those skilled in the art will understand that the dimensions of the resulting deposit 50 can vary, however, in one embodiment, deposit 50 can have a thickness of from about 1.0 mm to about 2.0 mm, and in another embodiment about 1.3 mm. A plurality of layers of deposit 50 can be applied to build up MLE protective strip 28 to near net shape using motion control device 46 to control the placement and orientation of deposit stream 48. If needed, MLE protective strip 28 can be finished to final dimensions using conventional finishing techniques (e.g. machining).

The embodiments herein offer a variety of benefits over conventional MLE protective strip manufacturing technologies. More particularly, cold spray deposition allows the leading edge protective strip to be built up to near net shape, thereby reducing material input, material waste, and overall manufacturing time. Applying only the amount of material needed to complete the component conserves expensive raw materials, and material removal and finishing needs (e.g. machining) are drastically reduced. Additionally, because of the low temperature of operation, cold spray deposition will not degrade or alter the metallurgical properties of the MLE protective strip, or damage or burn the underlying composite substrate. Moreover, deposition of the MLE protective strip directly onto the composite airfoil can improve the bond therebetween when compared to adhesive methods currently practiced.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for making a leading edge protective strip for a composite airfoil comprising:
utilizing a cold spray deposition system to deposit a protective strip onto a leading edge of the composite airfoil.

2. The method of claim 1 wherein the protective strip comprises a metal selected from the group consisting of titanium, titanium alloy, nickel-chromium alloy, aluminum, and combinations thereof.

3. The method of claim 2 wherein the composite comprises a material selected from the group consisting of carbon fibers, graphite fibers, glass fibers, ceramic fibers, aramid polymer fibers, and combinations thereof.

4. The method of claim 3 wherein utilizing the cold spray deposition system comprises:
feeding a first gas stream and a second gas stream into a nozzle, the first gas stream being heated and the second gas stream comprising a metallic powder;
combining the first gas stream and the second gas stream in the nozzle to form a deposit stream; and
applying the deposit stream to the composite airfoil to build up a deposit and form the metal leading edge protective strip.

5. The method of claim 4 comprising feeding the first gas stream heated to a temperature of from about 260° C. to about 1038° C. into the nozzle.

6. The method of claim 5 comprising feeding the second gas stream comprising a metallic powder selected from the group consisting of titanium, titanium alloy, nickel-chromium alloy, aluminum, and combinations thereof, and having a particle size of from about 5 micrometers to about 100 micrometers, into the nozzle.

7. The method of claim 6 comprising feeding the first gas stream and the second gas stream at a pressure of from about 50 psi to about 150 psi.

8. The method of claim 7 comprising applying the deposit stream to the composite airfoil at a velocity of from about Mach 0.5 to about Mach 1.0 and at a temperature of from about 200° C. to about 1000° C.

9. The method of claim 8 comprising applying a plurality of layers of the deposit, each layer of the deposit comprising a thickness of from about 1.0 mm to about 2.0 mm.

10. The method of claim 9 wherein the composite airfoil is a blade or vane.

11. A method for making a leading edge protective strip for a composite airfoil comprising:
utilizing a cold spray deposition system to deposit the protective strip onto a leading edge of the composite airfoil
wherein the protective strip comprises a metal selected from the group consisting of titanium, titanium alloy, nickel-chromium alloy, aluminum, and combinations thereof; and the composite comprises a material selected from the group consisting of carbon fibers, graphite fibers, glass fibers, ceramic fibers, aramid polymer fibers, and combinations thereof.

12. The method of claim 11 wherein utilizing the cold spray deposition system comprises:
feeding a first gas stream and a second gas stream into a nozzle, the first gas stream being heated and the second gas stream comprising a metallic powder;
combining the first gas stream and the second gas stream in the nozzle to form a deposit stream; and
applying the deposit stream to the composite airfoil to build up a deposit and form the metal leading edge protective strip
wherein the composite airfoil is a blade or vane.

13. The method of claim 12 comprising feeding the first gas stream heated to a temperature of from about 260° C. to about 1038° C. into the nozzle.

14. The method of claim 13 comprising feeding the second gas stream comprising a metallic powder selected from the group consisting of titanium, titanium alloy, nickel-chromium alloy, aluminum, and combinations thereof, and having a particle size of from about 5 micrometers to about 100 micrometers, into the nozzle.

15. The method of claim 14 comprising applying the deposit stream to the composite airfoil at a velocity of from about Mach 0.5 to about Mach 1.0 and at a temperature of from about 200° C. to about 1000° C.

16. A method for making a leading edge protective strip for a composite airfoil comprising:
feeding a first gas stream and a second gas stream into a nozzle, the first gas stream being heated to a temperature of from about 260° C. to about 1038° C., and the second gas stream comprising a metallic powder selected from the group consisting of titanium, titanium alloy, nickel-chromium alloy, aluminum, and combinations thereof;
combining the first gas stream and the second gas stream in the nozzle to form a deposit stream; and
applying the deposit stream to the composite airfoil at a velocity of from about Mach 0.5 to about Mach 1.0 and at a temperature of from about 200° C. to about 1000° C. to build up a deposit and form the metal leading edge protective strip.

17. The method of claim 16 wherein the composite airfoil comprises a material selected from the group consisting of carbon fibers, graphite fibers, glass fibers, ceramic fibers, aramid polymer fibers, and combinations thereof.

18. The method of claim 17 wherein the composite airfoil is a blade or vane.

19. The method of claim 18 wherein the metallic powder comprises a particle size of from about 5 micrometers to about 100 micrometers.

20. The method of claim 19 comprising applying a plurality of layers of the deposit, each layer of the deposit comprising a thickness of from about 1.0 mm to about 2.0 mm.
